(19) United States
(12) Patent Application Publication
(10) Pub. No.: US 2026/0054174 A1
(43) Pub. Date: Feb. 26, 2026

(54) DATA PROCESSING APPARATUS AND METHOD

(71) Applicant: Sony Interactive Entertainment Inc., Tokyo (JP)

(72) Inventors: Jason Craig Millson, London (GB); Nicholas Anthony Edward Ryan, London (GB); Ryan John Spick, London (GB); Adrian Barahona Rios, London (GB)

(73) Assignee: Sony Interactive Entertainment Inc., Tokyo (JP)

(21) Appl. No.: 19/304,383

(22) Filed: Aug. 19, 2025

(30) Foreign Application Priority Data
Aug. 22, 2024 (GB) 2412392.9

(51) Int. Cl. A63F 13/5372; A63F 13/52; G06T 7/12; G06T 17/00; G06V 10/25; G06V 10/764; G06V 20/70

(52) U.S. Cl. CPC A63F 13/5372; A63F 13/52; G06T 7/12; G06T 17/00; G06V 10/25; G06V 10/764; G06V 20/70; G06V 2201/07

(57) ABSTRACT

A data processing apparatus including circuitry that obtains virtual object data representing a virtual object of a video game; inputs the virtual object data to a machine learning (ML) model that determines one or more interaction regions of the virtual object, the one or more interaction regions being regions of the virtual object which can be interacted with by a character of the video game; and obtains, as an output of the ML model, interaction region data representing the determined one or more interaction regions.

### CROSS-REFERENCE TO RELATED APPLICATIONS

This application claims the benefit of and priority to United Kingdom (GB) Application No. 2412392.9, filed Aug. 22, 2024, the entire disclosure of which is incorporated by reference herein in its entirety for all purposes.

### BACKGROUND

### Field of the Disclosure

This disclosure relates to a data processing apparatus and method.

### Description of the Related Art

The “background” description provided is for the purpose of generally presenting the context of the disclosure. Work of the presently named inventors, to the extent it is described in the background section, as well as aspects of the description which may not otherwise qualify as prior art at the time of filing, are neither expressly or impliedly admitted as prior art against the present disclosure.

In a video game, a virtual world comprising virtual objects may be generated. A user is then able to a control a video game character to move around the virtual world and interact with the virtual objects. For example, the video game character may be controlled to pick up particular objects (e.g. stone, bottles, chairs) or change the state of particular objects (e.g. opening a door of a car) by interacting with them.

It can be challenging to ensure the appearance of the character interacting with an object is realistic. For example, in many earlier video games involving characters opening car doors, the door would simply appear to instantly transition from a closed state to an open state in response to a character being controlled to open the door without any part of the character touching with or engaging with the door. Events such as this are not realistic and can thus negatively affect the realism of the video game.

More modern video games often incorporate more sophisticated interaction events. For example, when a character opens a car door in a more modern video game, a hand of the player will be shown to engage with a handle of the door and pull the door open. This is more realistic and helps make the video game more believable.

Such interactions are more complex to configure, however. In particular, whereas, for early video games, there simply needed to be a change in the state of an object in response to an interaction command (e.g. the user pressing a predetermined button when a character is close to a car to cause the car door to open), for more sophisticated interactions, further characteristics of the object and/or character need to be taken into account. For example, to ensure that the character appears to interact with the door handle when opening a door (rather than any of the part of the door), additional interaction data associated with the object needs to be provided to indicate the location of the door handle.

Providing interaction data for objects, however, is a time and labour intensive process, especially when there are many objects and/or many interaction regions. There is therefore a desire to address this problem.

### SUMMARY

The present technology is defined by the claims.

### BRIEF DESCRIPTION OF THE DRAWINGS

Non-limiting embodiments and advantages of the present disclosure are explained with reference to the following detailed description taken in conjunction with the accompanying drawings, wherein:

FIG. 1 schematically shows an example entertainment system;

FIG. 2 schematically shows example components associated with the entertainment system;

FIG. 3 schematically shows examples inputs and outputs of a machine learning model;

FIG. 4 shows example functionality of the machine learning model;

FIG. 5 shows an example training process of the machine learning model; and

FIG. 6 shows an example method.

Like reference numerals designate identical or corresponding parts throughout the drawings.

### DETAILED DESCRIPTION OF THE INVENTION

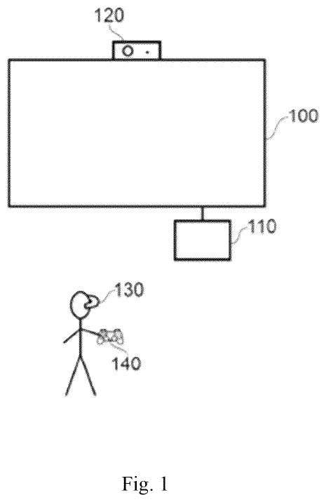

FIG. 1 schematically illustrates an entertainment system suitable for implementing one or more of the embodiments of the present disclosure. Any suitable combination of devices and peripherals may be used to implement embodiments of the present disclosure, rather than being limited only to the configuration shown.

A display device 100 (e.g. a television or monitor), associated with a games console 110, is used to display content to one or more users. A user is someone who interacts with the displayed content, such as a player of a game, or, at least, someone who views the displayed content. A user who views the displayed content without interacting with it may be referred to as a viewer. This content may be a video game, for example, or any other content such as a movie or any other video content. The games console 110 is an example of a content providing device or entertainment device; alternative, or additional, devices may include computers, mobile phones, set-top boxes, and physical media playback devices, for example. In some embodiments the content may be obtained by the display device itself—for instance, via a network connection or a local hard drive.

One or more video and/or audio capture devices (such as the integrated camera and microphone 120) may be provided to capture images and/or audio in the environment of the display device. While shown as a separate unit in FIG. 1, it is considered that such devices may be integrated within one or more other units (such as the display device 100 or the games console 110 in FIG. 1).

In some implementations, an additional or alternative display device such as a head-mountable display (HMD) 130 may be provided. Such a display can be worn on the head of a user, and is operable to provide augmented reality or virtual reality content to a user via a near-eye display screen. A user may be further provided with a video game controller 140 which enables the user to interact with the games console 110. This may be through the provision of buttons, motion sensors, cameras, microphones, and/or any other suitable method of detecting an input from or action by a user.

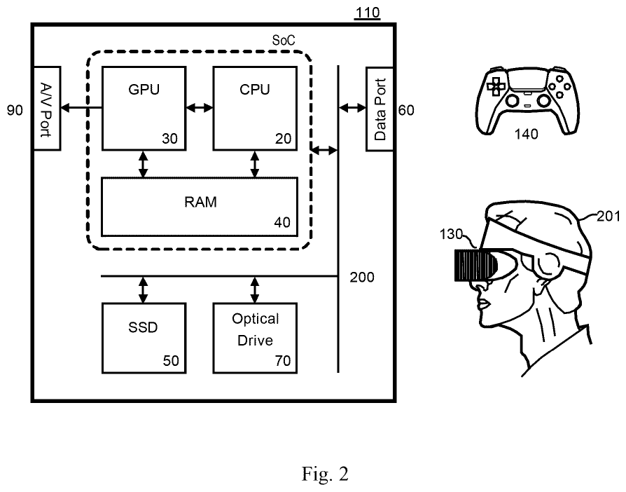

FIG. 2 shows an example of the games console 110. The games console 110 is an example of a data processing apparatus.

The games console 110 comprises a central processing unit or CPU 20. This may be a single or multi core processor, for example comprising eight cores. The games console also comprises a graphical processing unit or GPU 30. The GPU can be physically separate to the CPU, or integrated with the CPU as a system on a chip (SoC).

The games console also comprises random access memory, RAM 40, and may either have separate RAM for each of the CPU and GPU, or shared RAM. The or each RAM can be physically separate, or integrated as part of an SoC. Further storage is provided by a disk 50, either as an external or internal hard drive, or as an external solid state drive (SSD), or an internal SSD.

The games console may transmit or receive data via one or more data ports 60, such as a universal serial bus (USB) port, Ethernet® port, WiFi® port, Bluetooth® port or similar, as appropriate. It may also optionally receive data via an optical drive 70.

Interaction with the games console is typically provided using one or more instances of the controller 140. In an example, communication between each controller 140 and the games console 110 occurs via the data port(s) 60.

Audio/visual (A/V) outputs from the games console are typically provided through one or more A/V ports 90, or through one or more of the wired or wireless data ports 60. The A/V port(s) 90 may also receive audio/visual signals output by the integrated camera and microphone 120, for example. The microphone is optional and/or may be separate to the camera. Thus, the integrated camera and microphone 120 may instead be a camera only. The camera may capture still and/or video images.

Where components are not integrated, they may be connected as appropriate either by a dedicated data link or via a bus 200.

As explained, examples of a device for displaying images output by the game console 110 are the display device 100 and the HMD 130. The HMD is worn by a user 201. In an example, communication between the display device 100 and the games console 110 occurs via the A/V port(s) 90 and communication between the HMD 130 and the games console 110 occurs via the data port(s) 60.

The controller 140 is an example of a peripheral device for allowing the games console 110 to receive input from and/or provide output to the user. Examples of other peripheral devices include wearable devices (such as smartwatches, fitness trackers and the like), microphones (for receiving speech input from the user) and headphones (for outputting audible sounds to the user).

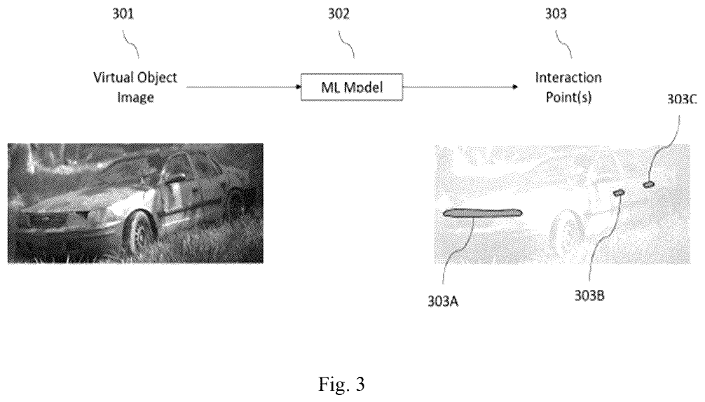

FIG. 3 shows a simplified example of how to automatically generate interaction data for a virtual object in a video game. Interaction data (interaction region data) is data indicating the location on the object of one or more interaction regions. An interaction region is a portion of the object which a video game character may interact with (e.g. in response to an interaction command issued by a user for a player-controlled character). For example, it is a region which a body part (e.g. hand or foot) of the character may touch or engage with (e.g. by pulling, pushing, twisting or the like). As previously discussed, a door handle is an example of an interaction region of a car.

In the example of FIG. 3, the virtual object is a car. The car is defined as a virtual three-dimensional (3D) object (3D car object) in the virtual world of the video game (e.g. as a mesh and textures). For each frame of the video game, the car 301 is rendered (e.g. by GPU 30) as a two-dimensional (2D) image 301. The apparent position and orientation of the car in the 2D image depends on the intrinsic and extrinsic parameters of a virtual camera which defines the point of view of a character looking at the car in the video game, for example.

The image 301 is an example of virtual object data (that is, data representing the virtual 3D car object), in particular virtual object image data, and is provided as an input to a machine learning (ML) model 302. The ML model 302 is executed by CPU 20, GPU 30 and/or one or more processors of an external data processing apparatus (not shown) which exchanges data with games console 110 via the data port 60, for example. The ML model 302 is trained to identify interaction regions of the object in the 2D image. In this example, three interaction regions are identified and interaction data for each interaction region (e.g. the locations of pixels in the 2D image defining a boundary defining each interaction region) is generated. A first interaction region 303A corresponds to a front edge of the hood of the car which may be grasped by a character to open the hood. A second interaction region 303B corresponds to a door handle of a front door of the car which may be pulled by a character to open the door. Similarly, a third interaction region 303C corresponds to a door handle of a rear door of the car which may be pulled by a character to open the door. Although only three interactions regions are shown here, it will be appreciated a different number of interaction regions may be identified (depending on the configuration and/or training of the ML model 302).

The ML model 302 comprises, for example, an instance segmentation model such as a mask R-CNN (Regions with Convolutional Neural Networks) model. The ML model 302 takes an input image (in this case, the image 301) and segments and identifies predetermined features in the image. In this case, the predetermined features are the interaction regions 303A-C. Training of the ML model 302 is discussed later.

Once the interaction regions 303A-C have been identified, the 2D positions of the pixels defining each interaction region (i.e. those defining and those within the boundary defining each interaction region) are used (with the intrinsic and extrinsic parameters of the virtual camera together with depth information of each pixel which is retained during the 2D image rendering) to determine the corresponding interaction regions of the 3D car object in the virtual world of the video game. That is, each pixel of each 2D interaction region of the 2D virtual object image 301 is mapped to a corresponding point of the 3D car object to generate corresponding 3D interaction regions of the 3D car object. 3D interaction data defining each of the 3D interaction regions (e.g. data defining positions along a boundary in virtual 3D space defining each 3D interaction region) is then associated with the 3D virtual object.

Once the 3D interaction data has been determined, interactions between a character of the video game and the 3D car object can be made to occur via appropriate one(s) of the determined 3D interaction regions, thereby helping improve the realism of the video game. For example, a character commanded to perform an opening action when in the vicinity of the car may be caused to make contact with an appropriate one of the 3D interaction regions corresponding to the 2D interaction regions 303A-C (with the animation of this contact then being rendered as 2D image for display to the user in the usual way).

For instance, if, in the virtual world, the character is located closest to the hood of the car when the opening action is commanded, the hand of the character may be shown as contacting the interaction region 303A when the state of the hood changes from an open state to a closed state. On the other hand, if the character is located closest to the front door of the car when the opening action is commanded, the hand of the character may be shown as contacting the interaction region 303B when the state of the front door changes from an open state to a closed state. Similarly, if the character is located closest to the rear door of the car when the opening action is commanded, the hand of the character may be shown as contacting the interaction region 303C when the state of the front door changes from an open state to a closed state.

The present technology thus allows interaction data to be generated for a virtual object automatically without the need for any manual configuration of the object. Rather, an existing virtual object with one or more states (e.g. a car with states of open or closed for each of the hood, trunk and each passenger door) may be defined without any interaction data and, through the use of ML model 302, interaction data is automatically generated for the virtual object. This interaction data can then be used to determine which part(s) of the virtual object a character should appear to touch or engage with when the character is commanded to interact with the object.

In one example, the ML model 302 may be trained to classify each detected interaction region (e.g. as “hood” for interaction region 303A or “door handle” for interaction regions 303B or 303C). For example, the classification may be executed as part of the instance segmentation. This allows different interaction commands (e.g. “open hood” vs “open door”) to then be associated with different respective interaction region classifications (e.g. so the command “open hood” causes the character to engage with interaction region 303A whereas the command “open door” causes the character to engage with the nearest one of the interaction regions 303B or 303C). This helps to provide a richer and more accurate gameplay experience.

In another example, no further classification of each detect interaction region (other than the fact it is an interaction region) is carried out and the character is instead controlled to engage with the nearest interaction region in response to an interaction command. This alleviates the need for classification of each interaction region (thereby alleviating the training burden of the ML model 302). In particular, it allows training the ML model 302 using unsupervised methods (as explained below). This may be particularly effective for virtual objects for which there is only one interaction type. For example, for a car, if the only interaction for which a character can be commanded is “open”, then, in response to this command, the character is caused to engage with the nearest of the interaction regions 303A-C. At the same time, the state of the nearest openable element (that is, the hood, front door or rear door) is changed to the “open” state.

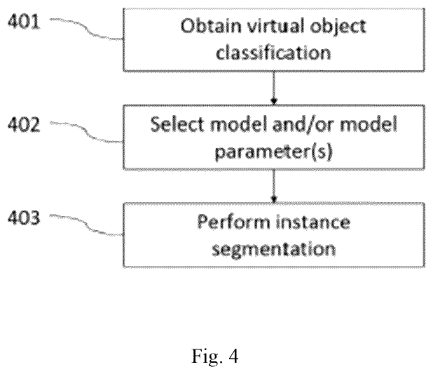

FIG. 4 shows example steps executed by the ML model 302. The ML model 302 may itself comprise one or more further ML models (which may be referred to as sub-models).

At step 401, object detection is performed on the current output rendered image frame (represented by image frame data) of the video game. The object detection comprises detecting object(s) in the frame, classifying those object(s) and enclosing (bounding) each object in a respective bounding box. Any suitable known object detection technique may be used, such as an R-CNN (which is a sub-model of the ML model 302). The image content within each bounding box (which is portion of the image frame) defines a virtual object image (like the virtual object image 301 of the car in FIG. 3). The classification comprises classifying the virtual object as one of a plurality of predetermined object classifications. In an example, the virtual objects to be detected are common types of objects (e.g. cars, etc.) and thus the model used for object detection at step 401 may be any suitable existing pre-trained object detection model (such as any suitable existing pre-trained R-CNN).

At step 402, for each detected object, an interaction region detection model and/or set of parameters of an interaction region detection model is selected and obtained depending on the classification of the detected object. In the following examples, the interaction region detection model is an instance segmentation (IS) model (although the present technique is not limited to this). Information defining each selectable IS model and/or parameters is stored in the SSD 50, for example. Thus, for example, for a detected object with classification “car” (as will occur for virtual object image 301, for example), a first IS model and/or set of parameters is selected and obtained. On the other hand, for a detected object with classification “table”, a second, different, IS model and/or set of parameters is selected and obtained. In an example, each IS model is a mask R-CNN model configured with a different respective set of parameters optimised for the object classification for which that IS model is used. This helps improve the accuracy of the subsequent instance segmentation using the select IS model and/or parameters and thus more accurate determination of interaction region(s) of commonly detected objects (see step 403).

A different IS model and/or set of parameters may thus defined for each of a plurality of respective predetermined object classifications. One of the predetermined classifications may be an “unknown” or “other” classification to enable interaction regions to be determined for objects which do not fit with any of the other predetermined classifications. The IS model and/or set of parameters associated with the “unknown” or “other” classification may thus be a default IS model and/or set of parameters.

It is noted that step 402 is optional and, alternatively, there may be only a single IS model and/or set of parameters (e.g. the same default IS model and/or parameter set used for objects with an “unknown” or “other” classification) which is used for all detected objects. In this case, the classification step of detected object(s) in step 401 may also be omitted. This alleviates the processing and/or storage burden required in storing and selecting from a plurality of different IS models and/or parameter sets and may be appropriate when processing speed and efficiency is more important than interaction region accuracy.

In an example, a user may be presented with a selectable option (e.g. via an interactive menu or the like, not shown) to indicate whether they wish for different IS models and/or parameter sets to be selected for different object classifications (to provide more accurate interaction region determination) or for a single IS model and parameter set to be used (to alleviate the processing and/or storage burden).

The games console 110 may also make such a selection automatically depending on, for example, other processing and/or storage commitments associated with executing the video game. For example, if usage of the available CPU 20 and/or GPU 30 resources is below a predetermined threshold (e.g. 40, 50 or 60%), the CPU 20 may enable object classification and selection of different IS model and/or parameter sets for different object classifications. On the other hand, if the usage of the available CPU 20 and/or GPU 30 resources is above the predetermined threshold, the CPU 20 switches to enabling use of only a single default IS model and/or parameter set.

At step 403, the virtual object image (e.g. virtual object image 301) is input to the selected IS model (or default IS model if step 402 is omitted) and the IS model (which is a sub-model of the ML model 302) performs instance segmentation on the virtual object image to determine the interaction regions (e.g. interaction regions 303A-C) in the way previously described.

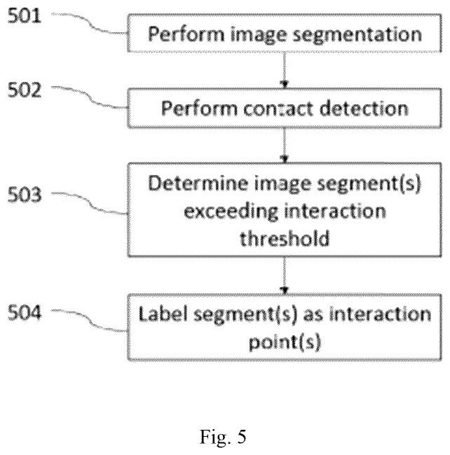

FIG. 5 shows example steps for unsupervised training of the IS model of step 403. As previously mentioned, unsupervised training may be used to enable appropriate classification of segments in a virtual object image as interaction regions, thereby alleviating the time and processing burden associated with supervised training of the IS model. In the example of FIG. 5, the unsupervised training uses real life video footage of an object (e.g. a car) captured by a camera.

At step 501, a training image is obtained and image segmentation is performed on the training image. In an example, the training image is a frame of a video of a training object which is interacted with by humans in the video. The training object corresponds to the virtual object for which interaction regions are to be determined. For example, when the virtual object is car, the video may be a captured video of a real car at a car show where attendees are able to interact with the car by opening its doors and the like.

The image segmentation may be performed using any suitable known image segmentation technique (such as edge detection or the like). In an example, object detection (e.g. again using R-CNN) is first used to detect the car in the training image and enclose the car in a bounding box. Image segmentation is then performed only on the image content within the bounding box. This allows different image segments of the car to be detected while reducing the overall processing burden (since image segmentation does not have to be performed for the entire image frame). Once the image segmentation has been executed, different segments of the car have been defined but have not yet been classified.

At step 502, contact detection between any human(s) in the training image and any of the detected image segments of the car is performed. Contact detection (interaction detection) comprises determining whether a detected part of a human body in the image is making contact with a detected object in the image. Any suitable known contact detection technique may be used. For example, the camera capturing the video may be calibrated in advance to map the 3D positions of points on the car in the scene to 2D positions in images captured by the camera. 3D human pose estimation may then be performed (using any suitable known 3D human pose estimation technique) for any detected human(s) in the training image to estimate the 3D position of the hands of the user with respect to the car. If a hand of the user is determined to be within a predetermined distance of the car (e.g. within an equivalent of 2, 3 or 5 cm), it is determined that the user's hand is making contact with the car. Alternatively, a contact detection technique such as the known “Human-Object conTact” (HOT) technique may be used. The image segment corresponding to the part of the car which has been made contact with is recorded as a contact segment.

Steps 501 and 502 are repeated for a plurality frames of the captured video (e.g. for every frame in 2, 5, 10, 30 or 60 minutes of video with frames being captured at 24 frames per second). Each frame is a respective training image to which steps 501 and 502 are applied.

At step 503, it is determined which image segments of the car have been recorded as a contact segment in at least a predetermined number of training images. This predetermined number may be referred to as an interaction threshold and may correspond, for example, 5, 10 or 20% of the total number of training images. Such image segments are determined to be interaction regions of the car. Using the interaction threshold in this way ensures only image segments which are determined to be contacted (or touched) by a human sufficiently often during the captured of the training images are recorded as interaction regions. This helps separate image segments which are only occasionally touched by a human (e.g. windows, door mirrors, etc.) and which are thus less likely to be common interaction regions from image segments which are often touched by a human (e.g. door handles) and which are thus more likely to be common interaction regions. This helps the image segments corresponding to interaction regions to be automatically determined more reliably.

Alternatively, rather than using the interaction threshold, the number of times each image segment is made contact with in the training images over the duration of the video may be recorded and a predetermined number of the most contacted image segments (e.g. the top, top 3 or top 5) are determined as interaction regions. The contact information of the image segments (i.e. number of times each image segment is contacted over the duration of the video) thus defines the equivalent of a heat map in which image segments contacted more often (and which are thus more likely to correspond to interaction regions) are distinguished from image segments contacted less often (and which are thus less like to correspond to interaction regions).

At step 504, each image segment determined to be an interaction region is labelled as an interaction region.

In steps 503 and 504, detected image segments are consistent between different training images. In an example, a correspondence between image segments in different training images is made. For example, a first image segment in a first training image is considered as corresponding to a second image segment in a second training image if a centre of mass (CoM) position of the second image segment is within a predetermined distance (e.g. 5 or 10 pixels) of the CoM position of the first image segment and a difference in the respective pixel areas of the first and second image segments is within a predetermined threshold (e.g. within 5%). Corresponding image segments are flagged as belonging to a same particular segment type and that segment type is associated with the total number of times the image segments of the segment type are recorded as a contact segment. If this total number exceeds the interaction threshold, then all image segments of the segment type are classified as interaction regions.

The result of steps 503 and 504 is thus a set of segmented training images in which corresponding image segments which are contacted by a hand of a user sufficiently regularly are labelled for each image as interaction regions (with the remaining image segments in each training image either not being labelled or being labelled as a “non-interaction region” or similar). A labelled training data set for training the IS model(s) of ML model 302 is thus generated automatically.

Steps 503 and 504 also automatically take into account changes in state of the object (e.g. when a door of the car is open vs closed). For example, if image segment correspondence is determined between each training image and all other training images, image segments of a car door handle in images where the door is open will be determined to be of the same first segment type. Similarly, image segments of a car door handle in images where the door is closed will be determined to be of the same second segment type. In either case, if sufficiently regular contact with the door handle by humans is recorded, both segment types will be determined as corresponding to an interaction region and a segment of either type in a given training image will be labelled as such. The present technology thus provides a highly flexible and reliable way of generating a training data set for a given IS model.

Each IS model is then trained using the automatically labelled training images. In an example in which a single IS model is used, automatically labelled training images of a plurality of different object types (e.g. car, table, etc.) are used to train the IS model. In another example where different IS models and/or model parameters are used for different respective object types (e.g. as determined via steps 401 and 402 of FIG. 4), each IS model is trained using automatically labelled training images of that object type. For example, for the IS model associated with the object classification “car”, only automatically labelled training images of cars are used to train the IS model, thereby improving the accuracy of the interaction region determination for that particular type of object. In an example, the same base IS model (e.g. a mask R-CNN model) is used for all object classifications but the parameters used are changed depending on the object classification. The parameters for each object classification are determined by training the IS model using only automatically labelled training images of objects falling within that classification.

In an example, instead of using real life video images captured by a calibrated camera as training images, computer generated video images may be used instead. For example, a developer may manually design a car object and specify the specific interaction region which may then be interacted with by artificial intelligence (AI) characters in an animation. The frames of this animation may then be captured and used as training images in the way described. This helps reduce the need for costly real life camera calibration and video capture and allows, for example, the work of manually configuring interaction regions of a virtual object to be completed only a small number of times to generate the training data for training the ML model 302 (in particular, training the IS model(s) of ML model 302). The ML model 302 is then used for the subsequent identification of interaction regions in previously unseen objects in the way described.

Interaction regions of objects determined using the present technology may be interacted with by player controlled characters or non-player characters (NPCs) in the video game.

Although the above-mentioned examples relate to the car virtual object of FIG. 3, it will be appreciated the described principles are applicable to any object which may be detected (and, if appropriate, classified) and interacted with by an in-game character. A door of a building (in which the door handle is identified as an interaction region), a table (in which the table legs are identified as interaction regions) or an openable box or trunk (in which the lid is identified as an interaction region) are examples of such objects. Such objects (some of which, like the door and box/trunk, will have a changeable state when interacted with by an in-game character) can thus be included in the video game without the need for manual configuration of interaction regions. The interaction regions are then configured automatically according to the described principles.

This also has the advantage that interaction regions of newly generated objects may be automatically determined. For example, if a character breaks a table object in half to generate two new half tables (this being a preconfigured state of the table object), each of the two new half tables (which the character might otherwise not be able to further interact with in a realistic way) will still be classified as a “table” (since they still have two table legs and half the table top). Interaction regions (e.g. the two table legs) can thus be determined to enable more realistic interaction with these newly generated half tables.

It is also noted that more interaction regions than those exemplified in FIG. 3 for the car virtual object may be identified, including, for example, internal interaction regions of the car (e.g. steering wheel, seat, etc.).

The present technology may also be applied to small, simple objects (e.g. bottles, rocks, etc.) which the user may interact with by picking up. In this case, the object is classified (either as a specific object or simply an object which can be picked up) and the entire surface of the object is configured as an interaction region. This allows, for example, bottle or rock virtual objects to be defined and rendered without any further interaction configuration.

In the above examples, the present technology is applied during execution of a video game by games console 110 to enable the interaction regions of rendered virtual objects to be determined. However, the present technology may also be applied during video game development. For example, a video game developer may create a new object (e.g. with a suitable mesh and textures) and then use the ML model 302 (executed on a developer-side data processing apparatus (not shown)) to automatically identify the interaction regions. This helps alleviate the developer-side burden associated with the manual configuration of interaction regions, thus allowing high quality virtual objects which can be interacted with to be generated more quickly and efficiently. In this case, the interaction regions of the created virtual object are defined with the object (e.g. as metadata associated with the object) and thus the games console 110 itself does not need to define the interaction regions using the ML model 302. Such an approach is also beneficial for virtual objects created using generative AI, for example (where the shape and texture of the object may be automatically generated but interaction regions are not).

Once the interaction regions have been defined, the developer may also configure specific interactions for each interaction region. For example, for a car door handle as an interaction region, interaction code may be defined which triggers an animation of a user-controlled character's hand grasping and twisting the door handle in response to an interaction command being issued by the user when the character is within a predetermined distance of the car and closest to the car door handle. On the other hand, for an end of the car hood as an interaction region, interaction code may be defined which triggers an animation of the user-controlled character's hand gripping and raising the hood in response to an interaction command being issued by the user when the character is within the predetermined distance of the car and closest to the end of the hood. Such animations may be configured by the developer using kinematic game engine models and/or generative AI models, for example.

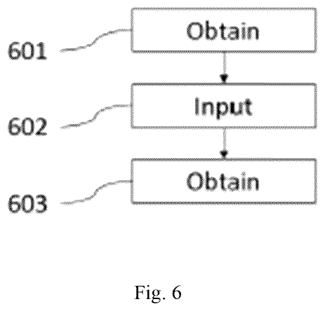

FIG. 6 shows an example method. The method is executed by CPU 20, GPU 30 and/or one or more processors of an external data processing apparatus (not shown) which exchanges data with the games console 110 via the data port 60, for example.

At step 601, virtual object data representing a virtual object of a video game is obtained.

At step 602, the virtual object data is put to a machine learning, ML, model configured to determine one or more interaction regions of the virtual object, the one or more interaction regions being regions of the virtual object which can be interacted with by a character of the video game.

At step 603, interaction region data representing the determined one or more interaction regions is obtained as an output of the ML model.

Example(s) of the present technique are defined by the following numbered clauses:
1. A data processing apparatus comprising circuitry configured to:
obtain virtual object data representing a virtual object of a video game;
input the virtual object data to a machine learning, ML, model configured to determine one or more interaction regions of the virtual object, the one or more interaction regions being regions of the virtual object which can be interacted with by a character of the video game; and
obtain, as an output of the ML model, interaction region data representing the determined one or more interaction regions.
2. A data processing apparatus according to clause 1, wherein the virtual object data comprises virtual object image data representing a rendered image of the virtual object.
3. A data processing apparatus according to clause 2, wherein the ML model is configured to:
receive image frame data representing a rendered image frame of the video game;
perform object detection to detect the virtual object in the rendered image frame, the object detection comprising bounding the virtual object in a bounding box; and
determining the one or more interaction regions of the virtual object using a portion of the rendered image frame defined by the bounding box.
4. A data processing apparatus according to clause 3, wherein:
the object detection comprises classifying the virtual object as one of a plurality of predetermined object classifications, each of the plurality of predetermined object classifications being associated with a respective interaction region detection model and/or with respective interaction region detection model parameters; and
determining the one or more interaction regions of the virtual object using the interaction region detection model and/or interaction region detection model parameters associated with the object classification of the virtual object.
5. A data processing apparatus according to any preceding clause, wherein the ML model comprises, as an interaction region detection model, an instance segmentation, IS, model configured to segment the rendered image of the virtual object and identify any segment of the rendered image corresponding to an interaction region of the virtual object.
6. A data processing apparatus according to clause 5, wherein the IS model has been trained by:
obtaining training images of a training object corresponding to the virtual object, the training images showing an interaction with the training object;
determining a number of interactions with each of one or more image segments of the training object in the training images;
determining which of the one or more image segments correspond to an interaction region based on the number of interactions with each image segment;
labelling each training image to indicate each image segment in the training image determined as corresponding to an interaction region; and
train the IS model using the labelled training images.
7. A data processing apparatus according to clause 6, wherein an image segment of the training object is determined to correspond to an interaction region when the number of interactions with the image segment exceeds a predetermined threshold.
8. A data processing apparatus according to clause 6, wherein an image segment of the training object is determined to correspond to an interaction region when the number of interactions with the image segment exceeds the number of interactions with one or more other image segments of the training object.
9. A data processing apparatus according to any one of clauses 6 to 8, wherein the training images are image frames of a video of the training object.
10. A data processing apparatus according to any preceding clause, wherein the one or more interaction regions of the virtual object are determined during execution of the video game.
11. A data processing apparatus according to one of clauses 1 to 9, wherein the one or more interaction regions of the virtual object are determined during creation of the virtual object during development of the video game and data indicating the one or more determined interactions regions is associated with the created virtual object.
12. A data processing apparatus according to clause 11, wherein an interaction is configurable for each of the one or more determined interaction regions.
13. A computer-implemented data processing method comprising:
obtaining virtual object data representing a virtual object of a video game;
inputting the virtual object data to a machine learning, ML, model configured to determine one or more interaction regions of the virtual object, the one or more interaction regions being regions of the virtual object which can be interacted with by a character of the video game; and
obtaining, as an output of the ML model, interaction region data representing the determined one or more interaction regions.
14. A program for controlling a computer to perform a method according to clause 13.
15. A computer-readable storage medium storing a program according to clause 14.

Numerous modifications and variations of the present disclosure are possible in light of the above teachings. It is therefore to be understood that, within the scope of the claims, the disclosure may be practiced otherwise than as specifically described herein.

In so far as embodiments of the disclosure have been described as being implemented, at least in part, by one or more software-controlled information processing apparatuses, it will be appreciated that a machine-readable medium (in particular, a non-transitory machine-readable medium) carrying such software, such as an optical disk, a magnetic disk, semiconductor memory or the like, is also considered to represent an embodiment of the present disclosure. In particular, the present disclosure should be understood to include a non-transitory storage medium comprising code components which cause a computer to perform any of the disclosed method(s).

It will be appreciated that the above description for clarity has described embodiments with reference to different functional units, circuitry and/or processors. However, it will be apparent that any suitable distribution of functionality between different functional units, circuitry and/or processors may be used without detracting from the embodiments.

Described embodiments may be implemented in any suitable form including hardware, software, firmware or any combination of these. Described embodiments may optionally be implemented at least partly as computer software running on one or more computer processors (e.g. data processors and/or digital signal processors). The elements and components of any embodiment may be physically, functionally and logically implemented in any suitable way. Indeed, the functionality may be implemented in a single unit, in a plurality of units or as part of other functional units. As such, the disclosed embodiments may be implemented in a single unit or may be physically and functionally distributed between different units, circuitry and/or processors.

Although the present disclosure has been described in connection with some embodiments, it is not intended to be limited to these embodiments. Additionally, although a feature may appear to be described in connection with particular embodiments, one skilled in the art would recognize that various features of the described embodiments may be combined in any manner suitable to implement the present disclosure.

What is claimed is:

1. A data processing apparatus comprising:
circuitry configured to:
obtain virtual object data representing a virtual object of a video game;
input the virtual object data to a machine learning (ML) model, the ML model configured to identify interaction regions for virtual objects, the interaction regions being regions of the virtual objects which can be interacted with by a character of the video game; and
obtain, as an output of the ML model, interaction region data representing one or more interaction regions of the virtual object.

2. The data processing apparatus according to claim 1, wherein the virtual object data comprises virtual object image data representing a rendered image of the virtual object.

3. The data processing apparatus according to claim 2, wherein the ML model is configured to:
receive image frame data representing a rendered image frame of the video game;
perform object detection to detect the virtual object in the rendered image frame, the object detection comprising bounding the virtual object in a bounding box; and
determining the one or more interaction regions of the virtual object using a portion of the rendered image frame defined by the bounding box.

4. The data processing apparatus according to claim 3, wherein:
performing the object detection comprises classifying the virtual object as one of a plurality of predetermined object classifications, each of the plurality of predetermined object classifications being associated with a respective interaction region detection model, respective interaction region detection model parameters, or a combination thereof; and
determining the one or more interaction regions of the virtual object using the interaction region detection model, interaction region detection model parameters, or a combination thereof associated with the object classification of the virtual object.

5. The data processing apparatus according to claim 2, wherein the ML model comprises, as an interaction region detection model, an instance segmentation (IS) model configured to segment the rendered image of the virtual object and identify any segment of the rendered image corresponding to an interaction region of the virtual object.

6. The data processing apparatus according to claim 5, wherein the IS model has been trained by:
obtaining training images of a training object corresponding to the virtual object, the training images showing an interaction with the training object;
determining a number of interactions with each of one or more image segments of the training object in the training images;
determining which of the one or more image segments correspond to an interaction region based on the number of interactions with each image segment;
labelling each training image to indicate each image segment in the training image determined as corresponding to an interaction region; and
training the IS model using the labelled training images.

7. The data processing apparatus according to claim 6, wherein an image segment of the training object is determined to correspond to an interaction region when the number of interactions with the image segment exceeds a predetermined threshold.

8. The data processing apparatus according to claim 6, wherein an image segment of the training object is determined to correspond to an interaction region when the number of interactions with the image segment exceeds the number of interactions with one or more other image segments of the training object.

9. The data processing apparatus according to claim 6, wherein the training images are image frames of a video of the training object.

10. The data processing apparatus according to claim 1, wherein the one or more interaction regions of the virtual object are determined during execution of the video game.

11. The data processing apparatus according to claim 1, wherein the one or more interaction regions of the virtual object are determined during creation of the virtual object during development of the video game and data indicating the one or more determined interactions regions is associated with the virtual object.

12. The data processing apparatus according to claim 11, wherein an interaction is configurable for each of the one or more determined interaction regions.

13. A method comprising:
obtaining virtual object data representing a virtual object of a video game;
inputting the virtual object data to an ML model, the ML model configured to identify interaction regions of virtual objects, the interaction regions being regions of the virtual objects which can be interacted with by a character of the video game; and
obtaining, as an output of the ML model, interaction region data representing one or more interaction regions of the virtual object.

14. A computer-readable storage medium storing a program which, when executed by a computer, causes a computer to perform a method comprising:
obtaining virtual object data representing a virtual object of a video game;
inputting the virtual object data to an ML model, the ML model configured to identify interaction regions of virtual objects, the interaction regions being regions of the virtual objects which can be interacted with by a character of the video game; and
obtaining, as an output of the ML model, interaction region data representing one or more interaction regions of the virtual object.
